(19) United States
(12) Patent Application Publication
(10) Pub. No.: US 2020/0382459 A1
(43) Pub. Date: Dec. 3, 2020

(54) Steganography mail block server implementation

(71) Applicant: Bank of America Corporation, Charlotte, NC (US)

(72) Inventors: David Scott Strubbe, Weddington, NC (US); Christopher Stott, Charlotte, NC (US); Christopher M. Quinn, Indian Trail, NC (US); James Brian Chilton, Cornelius, NC (US); Michael Edward Trudelle, Gastonia, NC (US)

(21) Appl. No.: 16/427,510

(22) Filed: May 31, 2019

(51) Int. Cl. H04L 12/58; H04L 29/06

(52) U.S. Cl. CPC H04L 51/08; H04L 51/10; H04L 65/602; H04L 63/0428; H04L 51/24

(57) ABSTRACT

Aspects described herein relate to a computer system preventing embedded data from being surreptitiously transmitted in attached image files of e-mail messages, where the embedded data is inserted using steganography. The computer system may include a Simple Mail Transfer Protocol (SMTP) e-mail server that transforms an attached image file and replaces the original attached image file with the transformed image file. If the attached image file comprises a stego-image file (where data is embedded in the image), a recipient of the e-mail is unable to extract the embedded data because the recipient does not know a centrally managed key. In addition, the computer system may store images that a user sends as attached files in e-mail messages over a predetermined time duration. If the user sends an e-mail message having an attached image that matches previously sent stored images, an alarm may be generated indicating a potential steganography e-mail event.

### TECHNICAL FIELD

One or more aspects of the disclosure generally relate to preventing embedded data from being surreptitiously transmitted in an attached image file of an e-mail message.

### BACKGROUND

Data security is an important measure for ensuring the integrity of an organization. In order to avoid data security, a perpetrator (sometimes considered a criminal) may encrypt data to circumvent data security measures. Because sophisticated means of intercepting encrypted files are currently available, perpetrators may focus on alternative ways of avoiding data security. One alternative approach is referred to as steganography (the digital equivalent of invisible ink), in which malevolence occurs in plain sight embedded in banner ads, text messages, audio files, and/or image files.

The problem is becoming so pervasive that the FBI in 2010 alleged that the Russian foreign intelligence service utilized customized steganography software for embedding encrypted text messages inside image files for certain communications with illegal agents (agents without diplomatic cover) stationed abroad. As example in the industrial domain, an engineer, who worked for a large U.S. company, was indicted in April 2019 for using an elaborate and sophisticated means to remove electronic files containing the company's trade secrets involving its turbine technologies. The engineer was alleged to have used encrypted technology to hide data files belonging to the company into an innocuous looking digital picture of a sunset and then to have e-mailed the digital picture, which contained the stolen data files of the company, to the engineer's private e-mail account.

Detecting the hidden data using steganography is often like finding a needle in a haystack. The technique makes it easy for perpetrators to surreptitiously transmit data-stealing malware. Consequently, any approach to counter illicit steganography activities would be beneficial to the art of data security.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

According to aspects described herein, a communication computing system includes an e-mail server (for example, supporting a Simple Mail Transfer Protocol (SMTP)), an attachment extraction engine, and a steganography plug-in. When the e-mail server receives an e-mail message from an originating client computer and the e-mail message includes an attached image file, the e-mail server extracts the attached image file. The attached image file may be a stego-image file carrying embedded data surreptitiously inserted by the user (sender of the e-mail) into the image file.

With another aspect of the embodiments, a steganography processing unit (for example a plug-in) receives an extracted stego-image file and transforms the extracted stego-image file using a centrally managed key with a desired degree of effect on the image to obtain a transformed stego-image file.

With another aspect of the embodiments, a steganography plug-in transforms the extracted stego-file with a non-noticeable effect on the image.

With another aspect of the embodiments, an e-mail server replaces the original attached stego-image file with a transformed stego-image file in an e-mail message and forwards the altered e-mail message to the recipient.

With another aspect of the embodiments, a recipient of an e-mail message is unable to extract embedded data from a transformed stego-image file because a centrally managed key is unknown to the recipient.

With another aspect of the embodiments, a computer communication system stores images that a user sends as attached files in e-mail messages over a predetermined time duration.

If the user sends an e-mail message having an attached image that matches previously sent stored images, an alarm may be generated indicating a potential steganography e-mail event.

With another aspect of the embodiments, a computer system replaces an attached image file with transformed image file in an e-mail message. With legitimate situations, the replacement is transparent to a user.

### BRIEF DESCRIPTION OF THE DRAWINGS

The present disclosure is illustrated by way of example and not limited in the accompanying figures in which like reference numerals indicate similar elements and in which:

FIG. 1 illustrates a computing system that processes e-mail messages in accordance with one or more example embodiments.

FIG. 2 illustrates a message flow between computing devices for transporting an e-mail message according to one or more illustrative embodiments.

FIG. 3 illustrates a communication computing device that supports e-mail service according to one or more illustrative embodiments.

FIG. 4 illustrates a process flow performed by the communication computing device shown in FIG. 3 according to one or more illustrative embodiments.

FIG. 5 shows an example of applying steganography to an image according to one or more illustrative embodiments.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

As discussed herein, a stego-file may contain image and/or audio content, where data is surreptitiously embedded in the image and/or audio content. A common approach is to embed the data in an image. For example, the least significant bit of a pixel may be overwritten by an encrypted stream of secondary stego-bits such that the primary public content of the image is not destroyed or distorted with notable artefacts. A stego-file may be directly transferred (for example, via file transfer protocol (FTP)) between computing devices or may be transported as an attachment in an e-mail message.

According to traditional approaches, a file is examined as to whether the file is a stego-file using a detection approach. Digital methodologies may be used on many common file types, including GIF, BMP, MP3, WAV, and JPG. Traditional approaches to counter stego-files include filtering different file types at the firewall, deleting inactive user accounts, being aware of files of unknown/questionable origin, and performing a file audit.

According to traditional approaches, when an embedded message is hidden in an image of a stego-file, one needs to check for all the possible ways that it may be a stego-file, given that the corresponding original image is typically unknown. There cannot be any universal algorithm to detect steganography. Consequently, detecting a stego-image file is typically very difficult and almost impossible with current technology. One theoretical approach is to store every possible image and to compare the image of the stego-image file with each stored possible image to determine if there is a subtle difference. This is hardly a viable approach with available technology (and may never be). With an aspect of the embodiments, as will be discussed, the above approach is circumvented.

With an aspect of the embodiments, direct detection of an attached image file is circumvented by transforming the attached image file so that the transformation has a non-noticeable effect on the image as perceived by a user. If the image were previously altered to convey embedded data, the obfuscation of the image would prevent a perpetrator from extracting the embedded data.

With an aspect of the embodiments, embedded data may be inserted into different types of files including, but not limited to, image files, video tiles, multi-media files, and audio files.

While some of the embodiments discussed herein are supported by an e-mail computer system, where one or one tiles are attached to an e-mail message, embodiments may support the transfer of files between computers such as via File Transfer Protocol (FTP).

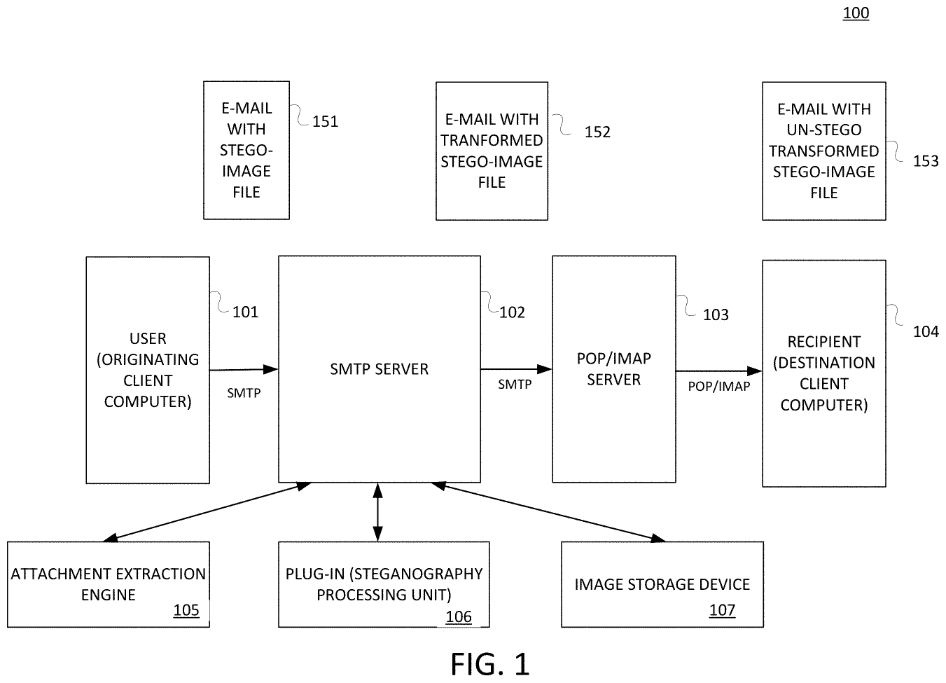

FIG. 1 illustrates computing system 100 that processes e-mail messages in accordance with one or more example embodiments.

Originating client computer 101 (associated with a user) sends e-mail message 151, which includes an attached stego-image file to SMTP (Simple Mail Transfer Protocol) server 102. However, SMTP server does not know whether or not the attached image file is a stego-image file. With either possibility, computing system 100 will transformed the attached image file as will be discussed.

While computing system 100 utilizes SMTP for e-mail transport, embodiments may utilize alternative e-mail protocols including, but not limited to, X.400 and Quick Mail Transport Protocol (QMTP).

With an aspect of the embodiments, SMTP server 102 utilizes an additional component to manipulate any attached image file by using its own steganography plug-in 106 with a centrally managed key. For example, the key may be known only to a security team and is used to unlock the second layer of the steganography. The key may be similarly managed as the private key side of PGP encryption. Plug-in 106 may comprise a software component (module) residing at SMTP server 102 or may be supported by a separate computing device that interacts with SMTP server 102.

SMTP server 102 extracts the attached image file from e-mail message 151 via attachment extraction engine 105 and presents the extracted image file to plug-in 106. With an aspect of the embodiments, the extracted image file may or not be a stego-image file. In either possibility, the image file is presented to plug-in 106.

Plug-in 106 transforms the extracted image file in a non-noticeable way to the user. For example, a computing device may transform the image so that the transformed image has the same pixel size and is close in byte count such that the image quality is not degraded.

With an aspect of the embodiments, plug-in 106 may utilize a steganography tool (known only to an administrator of SMTP server 102) to transform the extracted image file. As an example, StegHide is a steganography program that is able to hide data in various kinds of image and audio files. Detection of embedded data is resistant against first-order statistical tests.

With an aspect of the embodiments, the steganography transformation may be changed (for example, in a dynamic fashion) so that the transformation (for example, via the centrally managed key) is altered periodically to provide additional robustness to countering attempts by a user to embed data using steganography. In some embodiments, the transformation altered each e-mail message is sent.

SMTP server 102 replaces the original attached image file with the transformed image file and forwards e-mail message 152 to POP/IMAP server 103 for delivery to destination computer 104.

Server 103 may support different methods (for example, IMAP or POP) to access e-mail message 152. However, with an aspect of the embodiments, server 103 transparently forwards e-mail 152 to destination computer 104.

With an aspect of the embodiments, if the user were trying to use a steganography tool to embed data into the image-file, someone would no longer be able to un-stego the image at destination computer 104 to read (exfil) the embedded data.

Referring to FIG. 1, if a person (for example, someone outside an organization of originating computer 101) attempts to un-stego the attached image file of received e-mail message 153, the person would be unable extract the embedded data inserted into e-mail message 151 because server 102 has obfuscated the image that has hidden data in it. This is achieved by altering an image internally with no outward change to the image to the viewer. Consequently, the steganography attempt by the user is rendered null and void. It is a way to contain e-mail based stego completely Moreover, the containment is provided without impacting a business or worrying about false positive ratio mitigation using cloud scaling infrastructure or machine learning of any type.

Computing system 101 may also include image storage device 107 for storing images sent by the user during a predetermined time duration (for example, the previous 24 hours). As will be discussed in further detail, if the user attempts to send the same image or nearly the same image within the predetermined time duration, the attempt may be further scrutinized to determine if the user is potentially trying to send a stego-image file.

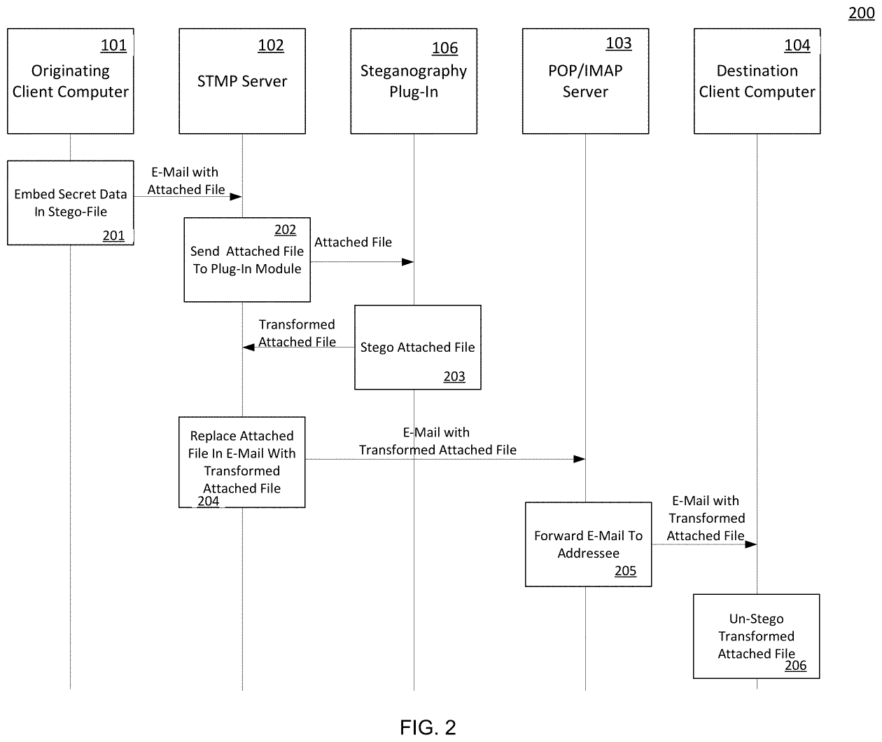

FIG. 2 illustrates message flow 200 between computing systems for sending an e-mail message according to one or more illustrative embodiments.

At block 201 embeds secret data in a stego image file and attaches it to e-mail sent via SMTP server 102 to someone at destination computer 104

At block 201, STMP server 102 extracts the attached image file and sends the attached image file to steganography plug-in 106 to be transformed. For example, plug-in 106 may apply some form of steganography (unknown to the user at computer 101) to transform the extracted image file.

At block 203, plug-in returns the transformed image file to SMTP server 102.

At block 204, server 102 replaces the attached image file with the transformed image file in the e-mail message and forwards the e-mail to the designated addressee (recipient) via POP/IMAP server 103. At block 205, server 103 completes delivery of the e-mail message to destination computer 104.

If the addressee believes that the attached image file contains embedded data (in other words, it is a stego-image file) the addressee attempts to un-stego the attached image file at block 206. Because the attached image file has been transformed by plug-in 106, the attempt to extract the embedded data will not be successful.

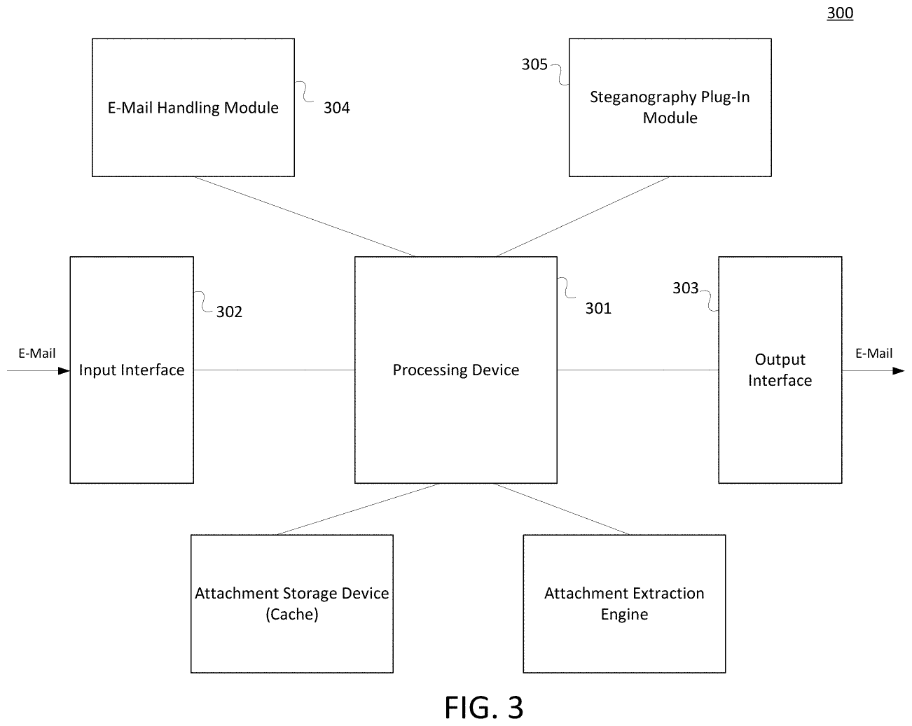

FIG. 3 illustrates a communication computing device 300 that supports e-mail service in computing system 100 shown in FIG. 1 according to one or more illustrative embodiments.

Referring to FIG. 1, communication computing device 300 may support the functionality of SMTP server 102, attachment extraction engine 105, plug-in 106, and image storage device 107.

Communication computing device 300 includes processing device 301 for controlling overall operation of the communication computing device 300 and its associated components, including one or more memory devices (not explicitly shown), input interface 302, and output interface 303.

Communication computing device 300 receives input information (e-mail messages) via input interface 302 and sends output information (processed e-mail messages) via output interface 303.

Communication computing device 300 typically includes a variety of computer readable media. Computer readable media may be any available media that may be accessed by processing device 301 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by processing device 301.

Computer-executable instructions may be stored within a memory device (not explicitly shown) and/or storage to provide instructions to a processor for enabling processing device 301 to perform various functions. For example, one or more memory devices may store computer-executable instructions used by processing device 301 to support e-mail handling module 304, steganography plug-in module 305, attachment extraction engine 306, an operating system, application programs, an associated database, and so forth. Alternatively, some or all of the computer executable instructions for computing device 301 may be embodied in hardware or firmware (not explicitly shown).

Embodiments of the invention may include forms of computer-readable media. Computer-readable media include any available media that can be accessed by a processing device 301. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

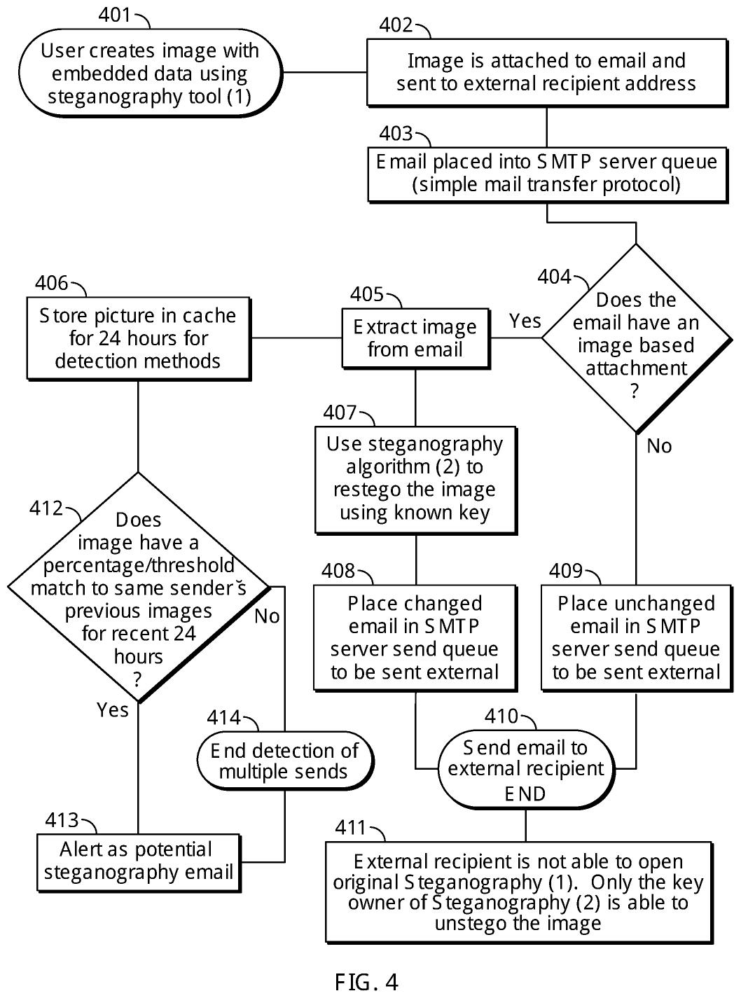

Communication computing device 300 may support the functionality flowchart 400 as shown in FIG. 4 and will be discussed in further detail. With some embodiments, communication computing device 300 corresponds to SMTP server 102, attachment extraction engine 105, steganography processing unit 106, and image storage device 107 as shown in FIG. 1.

E-mail handling module 304 may support the functionality of SMTP server 102 and may comprise computer-executable instructions executed by processor 301. The computer-executable instructions may be stored on one or more memory devices (not explicitly shown in FIG. 3).

E-mail handling module 304 may comprise computer-executable instructions (stored on a memory device not explicitly shown) executed by processing device 301 to provide the functionality of SMTP server 102 as shown in FIG. 1.

Steganography plug-in module 305 may comprise computer-executable instructions executed by processing device 301 to provide the functionality of plug-in 106.

Attachment extraction engine 306 provides the functionality of engine 105 as shown in FIG. 1 and may comprise executable-computer instructions that may correspond to a piece of software.

Although not required, various aspects described herein may be embodied as a method, a data processing system, or as a computer-readable medium storing computer-executable instructions. For example, a computer-readable medium storing instructions to cause a processor to perform steps (blocks) of a method in accordance with aspects of the invention is contemplated. For example, aspects of the method steps disclosed herein may be executed on processing device 301 on communication computing device 300.

Communication computing device 300 may operate in a networked environment supporting connections to one or more remote computers, such as terminals. The terminals may be personal computers or servers that include any or all of the elements described above with respect to the computing device. The network connections include a local area network (LAN) and a wide area network (WAN), but may also include other networks. When used in a LAN networking environment, the computing device may be connected to the LAN through a network interface or adapter. When used in a WAN networking environment, communication computing device 300 may include a modem or other network interface for establishing communications over the WAN, such as the Internet. It will be appreciated that the network connections shown are illustrative and other means of establishing a communications link between the computers may be used. The existence of any of various well-known protocols such as TCP/IP, Ethernet, FTP, HTTP, HTTPS, and the like is presumed. Computing device and/or terminals may also be mobile terminals (for example, mobile phones, smartphones, PDAs, notebooks, tablets, and the like) including various other components, such as a battery, speaker, and antennas (not shown).

The disclosure is operational with numerous types of general purpose or special purpose computing devices. Examples of well-known computing devices that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Another illustrative system for implementing methods according to the present disclosure may be used. The system may include one or more workstations. The workstations may be used by, for example, agents or other employees of an institution (for example, a financial institution) and/or customers of the institution. Workstations may be local or remote, and are connected by one or more communications links to computer network that is linked via communications links to the server. In the system, the server may be any suitable server, processor, computer, or data processing device, or combination of the same.

A computer network may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. The communications links may be any communications links suitable for communicating between the workstations and the server, such as network links, dial-up links, wireless links, hard-wired links, and the like.

FIG. 4 illustrates process flow 400 performed by communication computing device 300 (shown in FIG. 3) according to one or more illustrative embodiments.

At block 401, a user (corresponding to computer 101 as shown in FIG. 1) creates an image file with embedded data typically using a steganography tool. As an example, the user may utilize StegHide, which is a steganography program that is able to hide data in various kinds of image and audio files. At block 402, the image file is attached to an e-mail message to be sent to an external recipient address.

At block 403, the e-mail message is placed into a queue of SMTP server 102. At block 404, if the e-mail message does not include an attached image file, the e-mail message is placed unchanged and forwarded to the recipient via blocks 409 and 410.

If the e-mail message contains an attached image file as determined at block 404, the image file is extracted at block 405. For example, file extensions may be used to determine the type of file. At block 407, the extracted image file is transformed by a steganography method using a centrally managed key in order to re-stego the image.

At block 408, the attached image file is replaced by the transformed image file in the e-mail message and placed in the send queue of SMTP server 102 for delivery to the recipient at block 409.

At block 411, if the recipient attempts to open an attached stego-image file, the recipient would be unable to extract the embedded data because the recipient would not know the centrally managed key. If, however, the e-mail message contains an image file that is not a stego-image file, the recipient would be unaware of the transformation performed at block 407 since the transformation induces a non-noticeable effect on the image itself.

With an aspect of the embodiments, the above approach thwarts an exfiltration attempt since any original steganography embedded files would be cryptographically changed, and the recipient would no longer be able to retrieve embedded data.

In addition to obfuscating embedded data as described above, process 400 detects whether a user is potentially attempting to use steganography by monitoring for circumstantial events corresponding to blocks 406 and 412-414. While the detection is not conclusive, it does alert an administrator (for example, via an alarm) to further investigate the situation. Consequently, direct detection of stego-image files is circumvented.

At block 406, extracted image files are stored in a cache for a predetermined time (for example, 24 hours). At that time, the image file may be removed to preserve memory space.

At block 412, SMTP server 102 determines whether the extracted image file of the e-mail message has a percentage/threshold match to any of the user's previously sent images during the predetermined time duration. SMTP server 102 may determine the match in a number of ways. For example, threshold detection may be based on the number of times that the same image is sent by the same user. As another example, a percentage match may be performed on the image portion of the image file. The match may detect if the image file is slightly changed at the bit level but looks similar to a person and has been sent multiple times.

If a potential steganography attempt has been detected, an alarm is generated at block 413. If not, the detection process ends for the e-mail message at block 414.

In addition, while not explicitly shown in FIG. 4, process 400 may baseline out any images that a user always sends such as the logo in their signature that does not change over time.

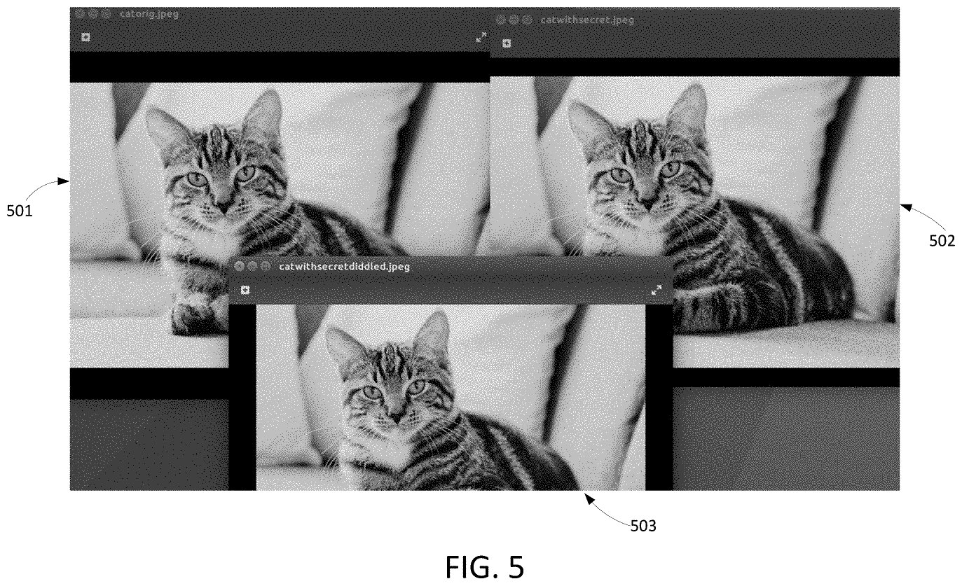

FIG. 5 shows an example of applying steganography to an image according to one or more illustrative embodiments.

With the hypothetical example shown in FIG. 5, a threat actor selects an original media file corresponding to image 501. The threat actor embeds secret data in the original file to obtain image 502. When the threat actor verifies that the secret data can be extracted from image 502, the threat actor attaches the file to an e-mail message sent via server 102 (as shown in FIG. 1) to an outside accomplice.

Even though server 102 does not know whether or not image 502 has embedded data, server 102 processes image 502 using its own steganography and a centrally managed key, as previously discussed, to obtain image 503. Consequently, server 102 □fuzzes □all attached images by applying its own steganography on the attached files.

While image 503 looks indistinguishable from image 501 (the original image), the additional steganography □breaks □any original steganography. However, if a user attaches an image for legitimate reasons, the additional steganography will be completely transparent (non-noticeable) to the user.

Various aspects described herein may be embodied as a method, an apparatus, or as computer-executable instructions stored on one or more non-transitory and/or tangible computer-readable media. Accordingly, those aspects may take the form of an entirely hardware embodiment, an entirely software embodiment (which may or may not include firmware) stored on one or more non-transitory and/or tangible computer-readable media, or an embodiment combining software and hardware aspects. Any and/or all of the method steps described herein may be embodied in computer-executable instructions stored on a computer-readable medium, such as a non-transitory and/or tangible computer readable medium and/or a computer readable storage medium. Additionally or alternatively, any and/or all of the method steps described herein may be embodied in computer-readable instructions stored in the memory and/or other non-transitory and/or tangible storage medium of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (for example, air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

1. A communication computing system comprising:
an e-mail server configured to receive a first e-mail message from an originating client computer, wherein the first e-mail message includes an attached stego-image file, the attached stego-image file conveying an image, and the originating client computer is assigned to a user;
an attachment extraction engine configured to extract the attached stego-image file from the first e-mail message;
a steganography processing unit configured to dynamically change a centrally managed key and to receive the extracted stego-image file, to transform the extracted stego-file by the centrally managed key with a desired degree of effect on the image to obtain a transformed stego-file, and to return the transformed stego-file to the e-mail server, wherein the centrally managed key is periodically altered when processing a series of e-mail messages that includes the first e-mail message; and
the e-mail server configured to replace the attached stego-image file with the transformed stego-file in the first e-mail message and to forward the first e-mail message to an addressee of the first e-mail message.

2. The communication computing system of claim 1, wherein the e-mail server supports a Simple Mail Transfer Protocol (SMTP).

3. The communication computing system of claim 1, wherein the attached stego-image file contains embedded data.

4. The communication computing system of claim 1 further comprising:
an image storage device configured to store the attached stego-image file for a predetermined time duration.

5. The communication computing system of claim 4, wherein the e-mail server is further configured to compare the attached stego-image file with stored image files of the user stored in the image storage device.

6. The communication computing system of claim 5, wherein the e-mail server is further configured to determine whether the attached stego-image file has a percentage/threshold match with any previous attached image file of the user occurred.

7. The communication computing system of claim 6, wherein the e-mail server is further configured to, when the attached stego-image file matches any said previous attached image file of the user, generates an alert indicative that a potential steganography email event occurred.

8. The communication computing system of claim 6, wherein the e-mail server is further configured to detect when the user previously sent a same image, as contained in the attached stego-image file, a pre-determined number of times.

9. The communication computing system of claim 6, wherein the e-mail server is further configured to percentage match on an image portion of the attached stego-image file.

10. The communication computing system of claim 6, wherein the e-mail server is further configured to baseline out any image that the user sends as a logo in a user's signature and that does not change with time.

11. The communication computing system of claim 4, wherein the image storage device is configured to delete the attached stego-image file when the predetermined time duration expires.

12. The communication computing system of claim 1, wherein the e-mail server is further configured to receive a second e-mail message from the originating client computer, wherein the second e-mail message includes an attached image file and wherein the attached image file does not contain embedded data.

13. The communication computing system of claim 1, wherein the e-mail server is further configured to receive a third e-mail message from the originating client computer, wherein the third e-mail message includes an attached stego-audio file.

14. The communication computing system of claim 1, wherein the steganography processing unit is configured to transform the extracted stego-file with a non-noticeable effect on the image.

15. A method for supporting security on an e-mail system, the method comprising:
receiving, from an originating client computer, an e-mail message, wherein the e-mail message includes an attached stego-image file, the attached stego-image file conveys an image, and the originating client computer is associated with a user;
extracting the attached stego-image file from the e-mail message;
transforming the extracted stego-file with a centrally managed key so that the image is affected in a non-noticeable way to the user;
periodically altering the centrally managed key when processing a series of e-mail messages;
reinserting the transformed stego-file into the e-mail message; and
forwarding the mail message to an addressee of the first e-mail message.

16. The method of claim 15, the method further comprising:
storing, at an image storage device, previous attached files of the user for a predetermined time duration.

17. The method of claim 16, the method further comprising:
determining whether the attached stego-image file has a percentage/threshold match with any previous attached image file of the user.

18. The method of claim 17, the method further comprising:
when the attached stego-image file matches any said previous attached image file, generating an alarm message indicative that a potential steganography email event has occurred.

19. (canceled)

20. One or more non-transitory computer-readable media storing computer-readable instructions that, when executed by an e-mail server, cause the e-mail server to:
receiving, from an originating client computer, an e-mail message, wherein the e-mail message includes an attached stego-image file, the attached stego-image file conveys an image, and the originating client computer is associated with a user;
extracting the attached stego-image file from the e-mail message;
transforming the extracted stego-image file with a centrally managed key so that the image is affected in a non-noticeable way to the user;
periodically altering the centrally managed key when processing a series of e-mail messages;
reinserting the transformed stego-image file into the e-mail message; and
forwarding the e-mail message to an addressee of the e-mail message;
determining whether the attached stego-image file has a percentage/threshold match with any previous attached image file of the user; and
when the attached stego-image file matches any said previous attached image file, generating alarm message indicative that a potential steganography email event has occurred.
